(19) United States
(12) Patent Application Publication
(10) Pub. No.: US 2023/0242838 A1
(43) Pub. Date: Aug. 3, 2023

(54) PREVENTION OF MCPD FORMATION BY HIGH TEMPERATURE WASHING

(71) Applicant: SOCIETE DES PRODUITS NESTLE S.A., Vevey (CH)

(72) Inventors: KORNEL NAGY, La Tour-De-Peilz (CH); XANTHIPPI THEURILLAT, Cheseaux-sur-Lausanne (CH); KARINE MEISSER REDEUIL, Pully (CH); MARINE NICOLAS, Morges (CH)

(21) Appl. No.: 17/999,723

(22) PCT Filed: May 26, 2021
(86) PCT No.: PCT/EP2021/064017

§ 371 Date: Nov. 23, 2022

(30) Foreign Application Priority Data
May 28, 2020 (EP) 20177213.4
Aug. 25, 2020 (EP) 20192747.2

(51) Int. Cl. C11B 3/16

(52) U.S. Cl. CPC C11B 3/16

(57) ABSTRACT

A method is provided for preventing or reducing the formation of monochloropropanediols (MCPDs) or monochloropropanediol esters (MCPDEs) in triacylglyceride oil, comprising the steps: (a) admixing the triacylglyceride oil with a liquid to form an admixture, wherein said liquid is selected from one or more of water, acid solution, base solution, phospholipid solution, 5 and surfactant solution; (b) optionally homogenizing the admixture; (c) performing one or more of the following steps 1. heating the admixture while homogenizing; and 2. heating the admixture; (d) cooling the admixture to under 100° C.; (e) optionally concentrating the insoluble and crystallized components from the admixture 1. by applying a centrifugational force to the admixture; and/or 2. by allowing insoluble and crystallized components in the admixture to 10 settle by gravity; (f) separating aqueous insoluble phase and crystallized components from the admixture and/or applying one or more processes to the admixture selected from degumming, physical refining, chemical refining, neutralization, interesterification, bleaching, dewaxing and fractionation. (g) applying heat treatment to the admixture.

### FIELD OF THE INVENTION

The present invention relates to the purification of oils. In particular, the invention relates to the improved washing purification of triacylglyceride oil to reduce or completely remove monochloropropandiol esters (MCPDEs) from refined oil.

### BACKGROUND TO THE INVENTION

3-Halogen-1,2-propandiols, in particular 3-monochloro-1,2-propandiol (3-MCPD), are known contaminants in foods (Food Addit. Contam. (2006) 23: 1290-1298). For example, studies have indicated that 3-MCPD may be carcinogenic to rats if administered at high doses (Evaluation of Certain Food Additives and Contaminants, World Health Organisation, Geneva, Switzerland (1993) 267-285; Int. J. Toxicol. (1998) 17: 47).

3-MCPD was originally found in acid-hydrolysed vegetable protein (acid-HVP; Z. Lebensm.-Unters. Forsch. (1978) 167: 241-244). More recently, it was found that refined edible oils may contain 3-MCPD in its fatty acid ester form, but only very little amounts of free 3-MCPD (Food Addit. Contam. (2006) 23: 1290-1298). The European Food Safety Authority (EFSA) has recommended that 3-MCPD esters are treated as equivalent to free 3-MCPD in terms of toxicity (European Food Safety Authority (2008)).

It has been reported that chlorination of acylglycerides can occur at very high temperatures, for example during the final step of the oil refining process, or deodorisation, under which oils may be heated under vacuum (3-7 mbar) up to 260-270° C. This may result in the formation of fatty acid esters of MCPD.

Effective mitigation routes for MCPD esters are limited and pose a challenge to the plant oil refining industry. Currently, the presence of 3-MCPD in refined oils is carefully monitored and oils with 3-MCPD content above a threshold value are discarded in order to ensure full compliance with EFSA recommendations.

As 3-MCPD may occur in many refined commercially important oils, such as plant oils, there exists a significant need for improved methods for removing and/or avoiding the production of such contaminants during oil refining.

### SUMMARY OF THE INVENTION

The inventors have developed a method by which MCPDs and MCPD ester (MCPDE including monoesters and diesters) formation during the process of oil refining can be substantially reduced or prevented.

The principle of the method is that a water washing purification process under heating conditions even above the regular 1 bar boiling point of water (100 Celsius), could be used to increase the co-solubilization of oil and water, thereby improving the washing efficacy and purify the oils from chlorine that originates either from the crude oil or from the bleaching clay. This way the method takes advantage of the accelerated diffusion of chlorine under heated conditions to improve the efficacy of water washing.

As a result, the insoluble and water soluble chlorine or chloride containing substances, which potentially serve as a chlorine source, are enriched in the aqueous fraction of the oil and can be thus separated from the oil to be refined. The separation can occur via mechanical treatment such as centrifugation, settling, filtration or conventional degumming or other refining processes. The method of the invention can be applied to crude or partially refined (e.g. centrifuged, degummed or bleached) triacylglycerol (also called triacylglyceride) oils which include but are not limited to palm oil, palm stearin, palm olein and their various fractions, palm kernel oil, coconut oil, sunflower oil, high oleic sunflower oil and their variants, canola/rapeseed oil, corn oil, soybean oil, fish oil, algae oil, oil obtained from yeast, oil obtained from fungi, cocoa butter and any mixtures or blends thereof.

The mechanical treatment can include centrifugation and/or settling either before, in between or after any other purification, refining or deodorization step.

The degumming step can include water degumming, acid degumming, dry degumming, base degumming, chemical refining, or combination thereof.

Once removed, the potential sources of chlorine are no longer available for the formation of chlorinated compounds, such as MCPDs, MCPD mono-esters and MCPD di-esters during the heating steps in oil refinement. Product oils low in chlorine carrying substances are thereby obtained and the purified oils may be subjected to various refining practices, such as heat treatment and deodorisation, in order to produce refined oils with reduced or no MCPDs and MCPDEs.

A further benefit of the method of the invention is that it enables lower temperatures to be used in deodorisation of the oil, which both
1) reduces trans-fatty acid formation (trans fat formation at high temperature is reviewed in Baley's industrial oil and fat products; Sixth Edition; Volume 5 Edible Oil and Fat Products: Processing Technologies; Chapter 8 Deodorization; section 3. Refined oil quality, subsection 3.2 Fat isomerization and degradation products).
2) reduces formation of glycidyl esters (see the summary of the elimination methods of GEs in “Glycidyl fatty acid esters in refined edible oils: a review on formation, occurrence, analysis, and elimination methods” in Comprehensive Reviews in Food Science and Food Safety; vol. 16, 263-281; 2017).

Accordingly, in one aspect the invention provides a method for preventing or reducing the formation of monochloropropanediols (MCPDs) or monochloropropanediol esters (MCPDEs) in triacylglyceride oil, comprising the steps:
(a) admixing a starting triacylglyceride oil with a liquid to form an admixture, wherein said liquid is selected from one or more of water, acid solution, base solution, phospholipid solution, and surfactant solution;
(b) optionally homogenizing the admixture;
(c) performing one or more of the following steps
   1. heating the admixture while homogenizing; and
   2. heating the admixture;
(d) cooling the admixture to under 100° C.;
(e) optionally concentrating the insoluble and crystallized components from the admixture
   1. by applying a centrifugational force to the admixture; and/or
   2. by allowing insoluble and crystallized components in the admixture to settle by gravity;
(f) separating aqueous insoluble phase and crystallized components from the admixture and/or applying one or more processes to the admixture selected from degumming, physical refining, chemical refining, neutralization, interesterification, bleaching, dewaxing and fractionation.
(g) applying heat treatment to the admixture.

In some embodiments, the starting triacylglyceride oil is a plant oil, animal oil, fish oil, yeast oil, fungi or algal oil, preferably a plant oil. The starting triacylglyceride oil refers to the triacylglyceride oil before it is admixed with a liquid in step (a) of the method.

In one embodiment, the liquid in step (a) is water.

The term “admixture” refers to the mixture obtained after adding the liquid of step (a) to the starting triacylglyceride oil and its subsequently derived versions through any technological step including homogenization, heating, cooling, purification, crystallization, centrifugation, settling, bleaching, mixing with other components, refining.

In some embodiments, the starting triacylglyceride oil is palm oil or fractions obtained from palm oil.

In some embodiments, the starting triacylglyceride oil is fish oil or fractions obtained from fish oil.

In some embodiments, the starting triacylglyceride oil is a crude oil.

In some embodiments, the starting triacylglyceride oil is a partially refined oil or oil mixture that has been purified either by centrifugation, settling, filtration, washing, dewaxing, fractionation, degumming, bleaching or deodorization or any combination of these.

In one embodiment, starting triacylglyceride oil has been water degummed without the use of an acid. The acid may include phosphoric acid, citric acid, sulphuric acid, formic acid, acetic acid.

In some embodiments, the starting triacylglyceride oil is a mixture of crude and partially refined oils.

In one embodiment, the starting triacylglyceride oil has been bleached.

In one embodiment, the starting triacylglyceride oil has been contacted with bleaching earth.

In one embodiment, the starting triacylglyceride oil has been mixed with bleaching earth.

In one embodiment, the starting triacylglyceride oil has been bleached with at least 0.01% (w/w), preferably at least 0.1% (w/w), more preferably at least 0.5% (w/w) bleaching earth.

In one embodiment, the starting triacylglyceride oil has been in contact with at least 0.01% (w/w), preferably at least 0.1% (w/w), more preferably at least 0.5% (w/w) bleaching earth.

In one embodiment, the starting triacylglyceride oil has been mixed with at least 0.01% (w/w), preferably at least 0.1% (w/w), more preferably at least 0.5% (w/w) bleaching earth.

In one embodiment, the starting triacylglyceride oil has been mixed with bleaching earth and the bleaching earth has been removed from the oil.

In one embodiment, the starting triacylglyceride oil has been mixed with bleaching earth and the bleaching earth has not been removed from the oil. In that case, triacylglyceride oil and bleaching earth mixture is subjected to further purification steps.

In one embodiment, the steps (c) includes heating to a temperature above 100° C. or 120° C. or 140° C. or 160° C. or 180° C. or 200° C.

In one embodiment, the steps (c) includes heating in a closed vessel under a pressure higher than 1 bar or 3 bars or 5 bars.

In one embodiment, the admixing of step (a) comprises incubating the starting triacylglyceride oil at a temperature greater than the melting temperature of the starting triacylglyceride oil, and/or homogenising the mixture.

In one embodiment, the step (a) admixture temperature is adjusted to a temperature of at least 10° C. above the melting point of the starting triacylglyceride oil.

In one embodiment, the step (a) admixture temperature is adjusted to a temperature of at least 20° C. above the melting point of the starting triacylglyceride oil.

In one embodiment, the step (a) admixture temperature is adjusted to a temperature of at least 30° C. above the melting point of the starting triacylglyceride oil.

In one embodiment, the step (d) admixture temperature is adjusted to a temperature of at least 10° C. above the melting point of the starting triacylglyceride oil.

In one embodiment, the step (d) admixture temperature is adjusted to a temperature of at least 20° C. above the melting point of the starting triacylglyceride oil.

In one embodiment, the step (d) admixture temperature is adjusted to a temperature of at least 30° C. above the melting point of the starting triacylglyceride oil.

In some embodiments, the aqueous phase of step (f) is separated from the triacylglyceride oil admixture by one or more of decantation, centrifugation, settling, pumping, and draining.

In some embodiments, the insoluble components comprise for example microparticles, segregated droplets, emulsions, suspensions and sediments.

In another embodiment, the heat treatment is done by deodorization, for example by steam distillation or short path distillation.

In another embodiment, the heat treatment of step (c) occurs in a closed vessel.

In one embodiment, the invention provides a method for preventing or reducing the formation of monochloropropanediols (MCPDs).

In one embodiment, the invention provides a method for preventing or reducing the formation of monochloropropanediol esters (MCPDEs).

In one embodiment, step (a) is performed and then step (c 1.) is performed.

In one embodiment, step (a) is performed and then step (c 2) is performed.

In one embodiment, step (a) is performed and then step (c 1) and step (c 2) are performed.

In one embodiment, step (a) is performed and then step (c 2) and step (c 1) are performed.

In one embodiment, step (b) is performed and then step (c 1.) is performed.

In one embodiment, step (b) is performed and then step (c 2) is performed.

In one embodiment, step (b) is performed and then step (c 1) and step (c 2) are performed.

In one embodiment, step (b) is performed and then step (c 2) and step (c 1) are performed.

In one embodiment, applying heat treatment in step (c) comprises exposing the oil to temperatures in the 120-220° C. range, more preferably in the 140-200° C. or in the 160-180° C. range. Preferably, heat treatment is applied for at least 2 minutes, more preferably at least 20 minutes.

In one embodiment, applying heat treatment in step (c) comprises exposing the oil to temperatures in the 140-200° C. range.

In one embodiment, the starting triacylglyceride oil is palm oil. In one embodiment, the starting triacylglyceride oil is palm oil and the heat treatment step in step (c) comprises exposing the oil to temperatures in the range 140-220° C.

In one embodiment, the starting triacylglyceride oil is fish oil. In one embodiment, the starting triacylglyceride oil is fish oil and the heat treatment step in step (c) comprises exposing the oil to temperatures in the range 140-220° C.

In one embodiment, the starting triacylglyceride oil is sunflower oil and the heat treatment in step (c) comprises exposing the oil to temperatures in the range 140-220° C.

In one embodiment, the quantity of the monochloropropandiols (MCPDs) or monochloropropandiol esters (MCPDEs) is measured after the heat treatment step (g).

In one embodiment, the quantity of the monochloropropanediols (MCPDs) or monochloropropandiol esters (MCPDEs) is measured after the heat treatment step (g), and wherein the quantity of the monochloropropanediols (MCPDs) or monochloropropandiol esters (MCPDEs) is reduced by at least 30% when compared to the non-purified but heat treated oil.

In one embodiment, the quantity of the MCPDEs in the heat treated oil of step (g) is reduced by at least a factor of two as measured by direct LC-MS.

In one embodiment, the starting triacylglyceride oil of step (a) is a crude triacylglyceride oil.

In one embodiment, the starting triacylglyceride oil has not been degummed before step (a)

In one embodiment, the starting triacylglyceride oil has been degummed before step (a).

In one embodiment, the starting triacylglyceride oil has not been bleached before step (a). In one embodiment, the starting triacylglyceride oil has not been fractionated before step (a).

In one embodiment, the starting triacylglyceride oil has been degummed before step (a). In one embodiment, the starting triacylglyceride oil has been bleached before step (a). In one embodiment, the starting triacylglyceride oil has been fractionated before step (a).

In one embodiment, the starting triacylglyceride oil has been neutralized before step (a).

In one embodiment, the starting triacylglyceride oil has not been neutralized before step (a).

In a preferred embodiment, the starting triacylglyceride oil has not been deodorised before step (a).

In one embodiment, the starting triacylglyceride oil is subjected to preliminary cleaning before step (a). In one embodiment, the starting triacylglyceride oil is subjected to preliminary refining before step (a). In one embodiment, the starting triacylglyceride oil is subjected to hydrogenation before step (a). In one embodiment, the starting triacylglyceride oil is subjected to interesterification before step (a).

In one embodiment, the starting triacylglyceride oil is a plant oil, animal oil, fish oil or algal oil.

In one embodiment, the starting triacylglyceride oil is crude palm oil and wherein the method starting with step (a) is applied.

In one embodiment, the starting triacylglyceride oil is a fractionated crude palm oil and wherein the method starting with step (a) is applied.

In one embodiment, the starting triacylglyceride oil is a crude palm kernel oil and wherein the method starting with step (a) is applied.

In one embodiment, the starting triacylglyceride oil is a fractionated crude palm kernel oil and wherein the method starting with step (a) is applied.

In one embodiment, the starting triacylglyceride oil is a crude coconut oil and wherein the method starting with step (a) is applied.

In one embodiment, the starting triacylglyceride oil is a fractionated crude coconut oil and wherein the method starting with step (a) is applied.

In one embodiment, the starting triacylglyceride oil is an oil obtained from algae, or yeast or fungi and wherein the method starting with step (a) is applied.

In one embodiment the starting triacylglyceride oil is crude fish oil.

In one embodiment the starting triacylglyceride oil is crude algae oil.

In one embodiment the starting triacylglyceride oil is crude fungi oil.

In one embodiment the starting triacylglyceride oil is crude yeast oil.

In one embodiment, the starting triacylglyceride oil is a crude seed oil and wherein the method starting with step (a) is applied. For example, the crude seed oil may be sunflower oil, canola/rapeseed oil, corn oil.

In a preferred embodiment, the starting triacylglyceride oil is a plant oil, preferably wherein the plant oil is selected from the group consisting of palm oil, sunflower oil, corn oil, canola oil, soybean oil, corn oil, coconut oil, palm kernel oil and cocoa butter.

In one embodiment, the starting triacylglyceride oil has a free fatty acid content of between 0.5-25% (w/w %), or a free fatty acid content of between 1-12% (w/w %), or a free fatty acid content of between 3-7% (w/w %).

In another embodiment, the starting triacylglyceride oil has a free fatty acid content at least 0.5 (w/w %), preferably 1 (w/w %), more preferably 3% (w/w %). In another embodiment, the starting triacylglyceride oil has a free fatty acid content of less than 25 (w/w %), preferably less than 15 (w/w %), more preferably less than 10% (w/w %).

In one embodiment, the starting triacylglyceride oil has not been admixed with any alkali such as sodium hydroxide or potassium hydroxide or any product comprising sodium hydroxide, or potassium hydroxide for example caustic soda, caustic potash. In another embodiment, the starting triacylglyceride oil has not been admixed with any ammonium hydroxide or any ammonium salt.

In one embodiment the starting triacylglyceride oil has not been admixed with a salt for example sodium salts, potassium salts, ammonium salts. Examples of sodium salts include sodium chloride, sodium hypochlorite, sodium carbonate, sodium formate, sodium citrate, sodium phosphate.

In another embodiment, the starting triacylglyceride oil has a soap content of less than 1000 ppm. In another embodiment, the starting triacylglyceride oil has a soap content of less than 20 ppm. In another embodiment, the starting triacylglyceride oil is devoid of soap.

In one embodiment the starting triacylglyceride oil has not been acidified or subjected to acid degumming.

In another embodiment, the starting triacylglyceride oil has not been admixed with an acid smaller than 195 Da. In a preferred embodiment, the starting triacylglyceride oil has not been admixed with an acid having its anhydrous form smaller than 195 Da.

In another embodiment, the starting triacylglyceride oil is devoid of acids smaller than 195 Da in a quantity greater than 0.01%. In another embodiment, the starting triacylglyceride oil is devoid of acids having an anhydrous form smaller than 195 Da in a quantity greater than 0.01%.

In another embodiment, the starting triacylglyceride oil does not comprise an acid that has a log P<1 in a quantity greater than 0.01%. In another embodiment, the starting triacylglyceride oil does not comprise an acid that has an acidity pKa1<5 in a quantity greater than 0.01%.

In another embodiment, the starting triacylglyceride oil is substantially devoid of any one of phosphoric acid, citric acid, sodium hydroxide, potassium hydroxide, boric acid, hypochloric acid and hydrochloric acid. As used herein, sodium hydroxide can mean caustic soda or alkaline, and potassium hydroxide can mean alkali potash.

In another embodiment, the starting triacylglyceride oil is substantially devoid of any one of phosphoric acid, citric acid, sodium chloride, sodium carbonate, sodium hydroxide, potassium hydroxide, phosphates, polyphosphates, acetic acid, acetic anhydride, calcium sulfate, calcium carbonate, sodium sulfate, boric acid, hypochloric acid, hydrochloric acid, and tannic acid.

In another embodiment, the starting triacylglyceride oil is substantially devoid of any added ionic, cationic and anionic surfactants. In another embodiment, the starting triacylglyceride oil is substantially devoid of any emulsifiers such as sorbitan esters or polyglycerol esters.

In another embodiment, the starting triacylglyceride oil is substantially devoid of any additive as listed in Bailey's Industrial Oil and Fat Products—6th edition, page 2236 in Chapter Emulsifiers for the food industry—Table 4, page 262], for example sucrose, glycol, propylene glycol and/or lactylates.

In one embodiment, the starting triacylglyceride oil has not been subjected to water degumming or wet degumming.

In one embodiment, the starting triacylglyceride oil has a moisture content of less than 1%, or less than 0.3%, or less than 0.1%.

In another embodiment, the starting triacylglyceride oil is admixed with water of more than 0.1%, or more than 0.5% or more than 1% or more than 3%.

In one embodiment the starting triacylglyceride oil is neutralized fish oil.

In one embodiment the starting triacylglyceride oil is neutralized algae oil.

In one embodiment the starting triacylglyceride oil is neutralized fungi oil.

In one embodiment the starting triacylglyceride oil is neutralized yeast oil.

In one embodiment, the starting triacylglyceride oil has a bleaching clay content of less than 0.01%. In another embodiment, the starting triacylglyceride oil has not been admixed with bleaching clay. In another embodiment, the starting triacylglyceride oil is devoid of bleaching clay.

In another embodiment, the starting triacylglyceride oil is devoid of added crystallization agents, for example solvents. Such solvents may include hexane, acetone and detergents described in [The Lipid Handbook—Third Edition; edited by Frank D. Gunstone; Chapter 4.4.2.] and in [Bailey's Industrial Oil and Fat Products—6th edition, Chapter 12] or sorbitan esters or polyglycerol fatty acid esters as described in [Omar et al Journal of Oil Palm Research Vol. 27 (2) June 2015 p. 97-106]. The starting triacylglyceride oil may be a crude palm oil.

In another embodiment, the starting triacylglyceride oil is devoid of added substances, for example degumming agents, neutralization agents, additives, solvents, salts, seeding agents, acids, bases or buffers.

In another embodiment, the starting triacylglyceride oil is a crude palm oil and is devoid of added substances, for example degumming agents, neutralization agents, additives, solvents, salts, seeding agents, acids, bases or buffers.

In one embodiment, the water used in step (a) contains added any one of phosphoric acid, citric acid, sodium chloride, sodium carbonate, sodium hydroxide, potassium hydroxide, phosphates, polyphosphates, acetic acid, acetic anhydride, calcium sulfate, calcium carbonate, sodium sulfate, boric acid, hypochloric acid, hydrochloric acid, and tannic acid.

In one embodiment, the starting triacylglyceride oil is pre-purified from insoluble materials by centrifugation.

In one embodiment, the starting triacylglyceride oil has a crystallized triacylglycerol content less than 10% (w/w %). In another embodiment, the starting triacylglyceride oil has a crystallized triacylglycerol content less than 5% (w/w %). In one embodiment, the starting triacylglyceride oil has a crystallized triacylglycerol content less than 2% (w/w %). In one embodiment, the starting triacylglyceride oil has a crystallized triacylglycerol content less than 0.5% (w/w %).

As used herein, crystallized triacylglycerols refer to solid state triacylglycerols or the solid part of fats. The solid fat content of fats & oils can be determined by pulsed Nuclear Magnetic Resonance [Bailey's Industrial Oil and Fat Products—6th edition, page 175 Chapter 5.2.1.]

In another embodiment, the starting triacylglyceride oil has not been cooled below 20° C., 15° C. or 10° C.

In another aspect, there is provided a purified triacylglyceride oil obtainable by the method of the invention.

In one embodiment the quantity of the monochloropropanediol esters (MCPDEs) in the heat treated purified oil of step (g) is lower by at least 30% compared to the non-purified but heat treated oil.

In one embodiment the quantity of the monochloropropanediol esters (MCPDEs) in the heat treated purified oil of step (g) is lower by at least 50% compared to the non-purified but heat treated oil.

There is also provided a purified triacylglyceride oil according to the invention, for use in the production of a food product.

There is also provided a food product, produced by using a purified triacylglyceride oil according to the invention.

### BRIEF DESCRIPTION OF THE DRAWINGS

FIG. 1— The key steps of examples 1, 3, and 4 summarized as a schematic.

FIG. 2—Benefit of two-steps high temperature washing of palm oil. The reduced level of MCPD diesters is demonstrated by LC-MS data.

FIG. 3—Benefit of two-steps high temperature washing of palm oil. The reduced level of overall 3-MCPD level is demonstrated by GC-MS data (AOCS method).

FIG. 4—The key steps of example 2 summarized as a schematic.

FIG. 5—Benefit of high temperature washing of already bleached palm oil. The reduced level of MCPD diesters is demonstrated by LC-MS data.

FIG. 6—Benefit of high temperature washing of already bleached palm oil. The reduced level of overall 3-MCPD level is demonstrated by GC-MS data (AOCS method).

FIG. 7— Results of sample analysis by the Official AOCS Cd 29b-13 method at SGS laboratory, confirming that the application of high temperature water washing without any bleaching process results in 3-MCPD reduction in dried oils.

FIG. 8— Results of sample analysis by the Official AOCS Cd 29b-13 method at SGS laboratory, confirming that the application of high temperature water washing in combination with bleaching process results in 3-MCPD reduction.

### DETAILED DESCRIPTION OF THE INVENTION

The terms “comprising”, “comprises” and “comprised of” as used herein are synonymous with “including” or “includes”; are inclusive or open-ended and do not exclude additional, non-recited members, elements or steps. The terms “comprising”, “comprises” and “comprised of” also include the terms “consisting of”, “containing” or “contains”.

Purification

The purification is particularly suitable for removing insoluble fraction of oils that may contain chlorine/chloride carrying contaminants (substances that may serve as the chlorine source needed for formation of monochloropropanediols (MCPDs) or monochloropropanediol esters (MCPDEs)) from a starting triacylglyceride oil. A starting triacylglyceride oil as used herein throughout is taken to mean the triacylglyceride oil immediately before it is subjected to step (a) of the method of the invention).

The method of the invention subjects the starting triacylglyceride oils to treatment that physically removes the water soluble and precipitated fraction of oils containing chloride/chlorine carrying substances, which may be an active source of chlorine during oil refining, from the starting (e.g. crude) oils. The treatment is based on an improved purification process under heating conditions even above the regular 1 bar boiling point of water (100 Celsius), that leverages the increased co-solubilization of oil and water, hereby improving the washing efficacy and purify the oils from chlorine that originates either from the crude oil or from the bleaching clay. This way the method takes advantage of the accelerated diffusion of chlorine under heated conditions to improve the efficacy of water washing. Note that it is of key importance that the temperature of this process must be below that threshold where the formation of MCPD esters starts. This latter is a threshold depending on the time of the heating, the type and chlorine content of the oil. As a general starting point, a 60 min treatment at 165° C. proved to be a condition where formation of MCPD esters still is not detectable by the herein applied LC-MS method.

As a result, the insoluble, sedimented, crystallized and water soluble chlorine or chloride containing substances, which potentially serve as a chlorine source, are enriched in the aqueous, and crystallized fraction of the oil and can be thus separated from the oil to be refined. The separation can occur via mechanical treatment such as centrifugation, settling, filtration or conventional degumming or other refining processes. The method of the invention can be applied to crude or partially refined triacylglycerol (also called triacylglyceride) oil which include but are not limited to palm oil, palm stearin, palm olein and their various fractions, palm kernel oil, coconut oil, sunflower oil, corn oil, high oleic sunflower oil and their variants, canola/rapeseed oil, soybean oil, fish oil, algae oil, oil obtained from yeast, oil obtained from fungi, cocoa butter and any mixtures or blends thereof.

The separation of insoluble aqueous phase and crystallized components from the triacylglyceride oil admixture can occur via filtration and/or decantation and/or centrifugation and/or settling and/or pumping and/or draining.

3-Halogen-1,2-propandiols, in particular 3-monochloro-1,2-propandiol (3-MCPD), are known contaminants in foods (Food Addit. Contam. (2006) 23: 1290-1298). For example, studies have indicated that 3-MCPD may be carcinogenic to rats if administered at high doses (Evaluation of Certain Food Additives and Contaminants, World Health Organisation, Geneva, Switzerland (1993) 267-285; Int. J. Toxicol. (1998) 17: 47). However, it has also been discovered that refined edible oils may contain 3-MCPD in its fatty acid ester form, while only containing very little amounts of free 3-MCPD (Food Addit. Contam. (2006) 23: 1290-1298). The European Food Safety Authority (EFSA) has recommended that 3-MCPD esters are treated as equivalent to free 3-MCPD in terms of toxicity (European Food Safety Authority (2008)).

It is well known that dehalogenation reactions can occur during thermal processes. For example, chlorine has been shown to leave chemical components as hydrogen chloride (gas) upon the input of sufficient activation energy, which is abundant during the deodorisation of vegetable oils at high temperatures (e.g. up to 270° C.). The inventors believe that hydrogen chloride may be evolved during oil refining from chlorine-containing compounds inherently present in the starting materials of the triacylglyceride oil refining process, for example plant materials.

Without wishing to be bound by theory, it is suggested that mechanistically, the MCPD di-esters may be formed during oil refinement via the protonation of the terminal ester group of triacylglycerides (TAG), which represent about 88-95% of total glycerides in most vegetable oils, through interaction with hydrogen chloride evolved during oil refining. The formed oxonium cation can then undergo intramolecular rearrangement, followed by nucleophilic substitution of chloride ion and the release of a free fatty acid and an MCPD di-ester.

Once removed through use of the method of the invention, the potential chlorine source is no longer available for the formation of chlorinated compounds, such as MCPD esters during the heating steps in oil refinement. Purified product oils are thereby obtained that will develop reduced quantity of monochloropropandiols (MCPDs) or monochloropropandiol esters (MCPDEs) when compared to the non-purified refined triacylglyceride oil when they are subjected to various refining practices with heat treatment e.g. deodorization.

In another embodiment, the quantity monochloropropandiol esters (MCPDEs) and MCPDs is reduced in the purified and heat treated triacylglyceride oil by at least 30%, 50%, 60%, 70%, 80%, 90%, 95% or 99% compared to the starting triacylglyceride oil that has only been heat treated but has not been purified.

Refined oils produced using the method of the invention may contain, for example, less than 3 ppm, less than 1.5 ppm, less than 1 ppm, less than 0.5 ppm, less than 0.3 ppm or preferably less than 0.1 ppm MCPDs.

Quantities of MCPDEs may be readily analysed using protocols well known in the art. For example, liquid chromatography/mass spectrometry (LC/MS)-based approaches are suitable for analysing levels of MCPDEs, as shown in the present Examples.

In one embodiment, the starting triacylglyceride oil input into step (a) of the method of the invention is crude triacylglyceride oil.

The term “crude oil” as used herein may refer to an unrefined oil. For example, in some embodiments, the starting triacylglyceride oil input into step (a) of the method of the invention has not been refined, degummed, bleached and/or fractionated. In a preferred embodiment, the starting triacylglyceride oil has not been deodorised before step (a).

In some embodiments, the starting triacylglyceride oil is subjected to preliminary processing before step (a), such as preliminary cleaning. However, any processes carried out on the starting triacylglyceride oil before step (a) preferably do not involve heating the triacylglyceride oil to a temperature greater than 100° C., 150° C., 200° C. or 250° C. In some embodiments, the triacylglyceride oil is subjected to preliminary refining, fractionation, hydrogenation and/or interesterification before step (a).

Triacylglyceride Oil

The term “triacylglyceride” can be used synonymously with “triacylglycerol” and “triglyceride”. In these compounds, the three hydroxyl groups of glycerol are each esterified by a fatty acid. Oils that may be purified using the method of the invention comprise triacylglycerides and include plant oil, animal oil, fish oil, algal oil and combinations thereof.

In a preferred embodiment, the starting triacylglyceride oil is a plant oil. Example, plant oils include sunflower oil, corn oil, canola oil, soybean oil, coconut oil, palm oil, palm kernel oil and cocoa butter.

In another embodiment, the starting triacylglyceride oil is palm oil or fractionated palm oil such as palm olein, palm stearin, mid-fraction.

In a preferred embodiment, the starting triacylglyceride oil is a crude plant oil.

In one embodiment the starting triacylglyceride oil is obtained from single cell organisms.

In one embodiment, the starting triacylglyceride oil is obtained from fish.

In one embodiment, the starting triacylglyceride oil is obtained from algae.

In one embodiment, the starting triacylglyceride oil is obtained from fungi.

In one embodiment, the starting triacylglyceride oil is obtained from yeast.

In another preferred embodiment, the starting triacylglyceride oil is crude palm oil or fractionated crude palm oil such crude palm olein, crude palm stearin, crude mid-fraction.

In one embodiment, the plant oil is crude palm oil. In one embodiment, the plant oil is crude corn oil. In one embodiment, the plant oil is crude sunflower oil. In one embodiment, the plant oil is cold pressed crude canola oil. In one embodiment, the plant oil is crude soybean oil.

In a preferred embodiment, the plant oil is at least partially solvent extracted. Preferably, the solvent is n-hexane or a mixture of 2-propanol and n-hexane.

Crude Triacylglyceride Oil

In the case of palm oil, crude oil may be produced from different portions of palm fruit, e.g. from the flesh of the fruit known as mesocarp and also from seed or kernel of the fruit. The extraction of crude palm oil (CPO) from the crushed fruits can be carried out under temperatures ranging for example from 90 to 140° C.

In other cases, for example sunflower, crude oil may be produced by pressing, by solvent extraction or the combination thereof, for example as described by Gotor & Rhazi in Oilseeds & fats Crops and lipids 2016 (DOI: 10.1051/ocl/2016007).

Refined Oils

As used herein, the term “refined” may refer to oils that have been subjected to methods that improve the quality of the oil and include a heat treatment. This heat treatment may be a deodorisation step comprising steam distillation or short path distillation. Such heat treatment can be applied in the 150-300° C. range, more commonly in the 160-260° C. or the 160-240° C. range.

Gum

As used herein, the term “gums” may refer to the sludge, deposited impurities of meal particles, crystallized waxes, sediments, glycolipids, sugars and mainly phospholipid and phosphatide based precipitates that vegetable oils will throw on storage, cooling or upon the addition of acid and/or water. Gums can be removed from oils by one or more of water degumming, acid degumming, water-acid degumming, super degumming, TOP degumming, UF degumming, organic refining, dry degumming, caustic refining, sedimentation, crystallization and settling, and centrifugation [Chapter 6 Enzymatic degumming by Ch. Dayton & F. Galhardo in Green Vegetable Oil Processing].

Gum Extract

As used herein, the term “gum extract” may refer to the gum obtained from an oil or any of its fractions or components.

Lecithins

As used herein, the term “lecithin” may refer to the water soluble fraction of “gums”. Accordingly, the term “gums” comprises the “lecithins” and “lysolecithins”.

Heat Treatment

As used herein, the term “heat treatment” may refer to exposing the oil to temperatures in the 150-300° C. range, more commonly in the 160-260° C. or the 160-240° C. range. The heat treatment may be applied in closed vessels or in ampoules or in combination with vacuum and/or steam as it is done in the industrial setting during deodorization (steam distillation or short path distillation).

Chlorine and Chloride

Chlorine is a chemical element with symbol CI and atomic number 17. Chlorine can be found in a wide range of substances both in ionic (e.g. sodium chloride) and covalent form (e.g. polyvinyl chloride). Accordingly, the terms “chlorine” and “chloride” both refer to substances that contain the chlorine element in various forms.

As used herein, the terms “chlorine containing”, “chloride containing”, “organochlorine”, “chlorine donor”, all refer to substances that in any format contain the chlorine element. This format can be either ionic, polar covalent or covalent.

Chlorine or Chloride Carrying Substances

As used herein, the terms “chlorine or chloride carrying substances” refer to substances that in any format contain the chlorine element. This format can be either ionic, polar covalent or covalent.

Chlorine Donor

As used herein, the terms “chlorine donor” refer to substances that in any format contain the chlorine element and may release the chlorine in any form for example but not restricted to hydrochloric acid, hypochlorite, chloride anion.

Acidity and pH

In chemistry, pH is a scale used to specify how acidic or how basic is a water-based solution. Similarly, as used herein, the term “pH” and the term “acidity” refer to the free acid content of the oil samples. For example when mixing the oil with phosphoric acid can be considered as lowering its pH. Similarly, a neutralization step with the addition of sodium hydroxide to the oil can be considered as increasing the pH of the oil.

Melting Temperature

The term “melting temperature” as used herein may refer to the temperature at which a solid changes state from solid to liquid at a pressure of 100 kPa. For example, the melting temperature may be the temperature at which a solid changes state from solid to liquid at a pressure of 100 kPa when heated at 2° C. per minute.

The skilled person is readily able to select suitable methods for the determination of the melting temperature of the triacylglyceride oil.

For example, apparatus for the analysis of melting temperatures may consist of a heating block or an oil bath with a transparent window (e.g. a Thiele tube) and a magnifier. A sample of the solid may be placed in a thin glass tube and placed in the heating block or immersed in the oil bath, which is then gradually heated. The melting of the solid can be observed and the associated melting temperature noted.

For fats and oils with highly complex triacylglycerol composition, the method of Slip Melting Point is a commonly used reference (AOCS Official method Cc 3-25).

Centrifugation

The term “centrifugation” as used herein may refer to the rapid rotation of a vessel including its oil content in order to exert centrifugal force on the vessel and its content.

In one embodiment, the centrifugation occurs at elevated temperatures at which the oil is in the liquid state. This temperature can be 30° C., 40° C., 50° C., 60° C., 70° C., 80° C., 100° C. or above for palm oil and 50° C., 60° C., 80° C., 100° C. or above for palm stearin, 15° C., 20° C. or above for palm olein, 5° C. or above for seed oils including sunflower oil, canola/rapeseed oil, corn oil. In a preferred embodiment, the temperature can be between 30° C. and 80° C. for palm oil, preferably between 35° C. and 70° C. In a preferred embodiment, the temperature can be between 5° C. and 20° C. for sunflower oil. In a preferred embodiment, the centrifugation speed is at least 15,000 g for 15 min.

Settling

The term “settle” or “settling” as used herein may refer to setting the oil vessel into a movement free or substantially movement free environment, preferably avoiding its disturbance for a period of time that can be at least 4 hours, 6 hours, 1 day, 2 days, a week or a month. In one embodiment, the oil vessel is settled into a fixed, movement free environment and its disturbance avoided for a period of time of at least 5 months, for example for crude sunflower oil or crude soybean oil. In one embodiment, the crude oil is heated to at least 60° C. prior to settling.

In one embodiment, the oil vessel is settled into a fixed, movement free environment and its disturbance avoided for a period of time of at least 4 days, for example for cold pressed crude canola oil.

Soap

As used herein, the term “soap” may refer to a variety of cleansing and lubricating products produced from substances with surfactant properties.

In the vegetable oil refining context and the current context the term “soap” is used to describe alkali carboxylates which are the salt of fatty acids formed by the negatively charged deprotonated fatty acid and a positively charged counter ion e.g. a sodium or a potassium cation. [Bailey's Industrial Oil and Fat Products—6th edition, page 3084— Soap raw materials and their processing page 105; Wikipedia]

As it is well known in the literature of alkali refining practices, free fatty acids react with alkali e.g. sodium hydroxide or potassium hydroxide to form such soaps [The Lipid Handbook—Third Edition; edited by Frank D. Gunstone; page 178, 191].

Further Refinement

As the water soluble and precipitated oil components along with their chlorine donor substances are depleted by the method of the invention, heating during any subsequent refinement processes will not cause significant generation of unwanted chlorinated compounds, such as the MCPDEs.

Processes for carrying out refinement, degumming, bleaching, deodorisation and fractionation are well known in the art.

By way of example, refinement of plant oil, such as vegetable oil, typically consists of physical refining or chemical refining.

In efforts aimed at increased sustainability, oil refineries have modified their plant oil processing lines in the past few decades for the minimisation of energy expenditure (economisers) and the reduction of waste. However, the steps of these two refining processes have essentially remained the same.

Physical refining is essentially an abridged form of chemical refining and was introduced as the preferred method of palm oil refining in 1973. It may be a three step continuous operation where the incoming oil is pre-treated with acid (degumming), cleansed by being passed through adsorptive bleaching clay, and then subjected to steam distillation. This process allows for the subsequent deacidification, deodorisation and decomposition of carotenoids unique to palm oil (i.e. the crude oil is deep red in colour, unlike other vegetable oils). Given the lack of neutralisation step in physical refining, refined bleached (RB) oil produced from a physical refinery contains nearly the same free fatty acid (FFA) levels as found in the crude oil.

Neutralised bleached (NB) oil from a chemical refinery and RB palm oil are comparable pre-deodorisation in every other aspect.

The heat bleaching unit operation is the main source of loss in the oil refining process resulting in 20-40% reduction in oil volume post filtration. The process typically lasts for about 30-45 min and typically takes place under 27-33 mbar vacuum at a temperature of 95-110° C.

Heat bleached oil may then be rerouted in piping to a deaerator that aides in the removal of dissolved gases, as well as moisture, before being sent to a deodorisation tower.

A bleaching step may comprise heating the oil and cleaning the oil by passing it through adsorptive bleaching clay.

A deodorisation step may comprise steam distillation.

The skilled person will understand that they can combine all features of the invention disclosed herein without departing from the scope of the invention as disclosed.

Preferred features and embodiments of the invention will now be described by way of non-limiting examples.

The practice of the present invention will employ, unless otherwise indicated, conventional techniques of chemistry, biochemistry, molecular biology, microbiology and immunology, which are within the capabilities of a person of ordinary skill in the art. Such techniques are explained in the literature. See, for example, Sambrook, J., Fritsch, E. F. and Maniatis, T. (1989) Molecular Cloning: A Laboratory Manual, 2nd Edition, Cold Spring Harbor Laboratory Press; Ausubel, F. M. et al. (1995 and periodic supplements) Current Protocols in Molecular Biology, Ch. 9, 13 and 16, John Wiley & Sons; Roe, B., Crabtree, J. and Kahn, A. (1996) DNA Isolation and Sequencing: Essential Techniques, John Wiley & Sons; Polak, J. M. and McGee, J. O'D. (1990) In Situ Hybridization: Principles and Practice, Oxford University Press; Gait, M. J. (1984) Oligonucleotide Synthesis: A Practical Approach, IRL Press; and Lilley, D. M. and Dahlberg, J. E. (1992) Methods in Enzymology: DNA Structures Part A: Synthesis and Physical Analysis of DNA, Academic Press. Each of these general texts is herein incorporated by reference.

### EXAMPLES

Analytical Procedures Used in the Examples

Relative Quantification of MCPDE by LC-MS

Sample Preparation

Oil samples were diluted stepwise prior to injection.
1) Firstly, 100 μL of each sample was transferred into a vial and 900 μL of a mixture of n-Hexane:Acetone (1:1 v/v) was added. The sample was vortexed for 5-10 s.
2) In the second step, 50 μL of this solution was further diluted by mixing it with 950 μL of acetone. The obtained solution was vortexed for 5-10 s.
3) 100 μL of this latter solution was mixed with 90 μL of methanol and 10 μL of internal standard mix solution. (the internal standard mix solution contained at 2 ng/μL concentration the following stable isotope labeled compounds solubilized in methanol: 1-oleoyl 2-linoleoyl 3-chloropropanediol-²H₅ (OL), 1-2-dipalmitooyl 3-chloropropanediol-²H₅ (PP), 1-palmitoyl 2-oleoyl 3-chloropropanediol-²H₅ (PO), 1-palmitoyl 2-linoleoyl 3-chloropropanediol-²H₅ (PL).

LC Conditions

Ultra high performance liquid chromatography was performed using a Waters Acquity H-class system equipped with a silica based octadecyl phase (Waters Acquity HSS C18, 1.7 μm; 2.1×150 mm). The applied solvent gradient is summarised in Table 3.

TABLE 3
Details of the applied LC gradient (solvent A was
1 mM ammonium-formate in methanol; and solvent
B was 100 μM ammonium-formate in isopropanol).

| Time | Solvent A | Solvent B | Flow rate |
|---|---|---|---|
| [min] | [%] | [%] | [μL/min] |
| 0 | 100 | 0 | 400 |
| 15.0 | 100 | 0 | 300 |
| 18.0 | 50 | 50 | 200 |
| 25.0 | 0 | 100 | 200 |
| 32.5 | 0 | 100 | 180 |
| 33.0 | 0 | 100 | 150 |
| 35.0 | 100 | 0 | 150 |
| 40.0 | 100 | 0 | 400 |
| 42.0 | 100 | 0 | 400 |

MS Conditions

Monitoring of monochloropropandiol (MCPD) esters was performed using Thermo Fisher high resolution mass spectrometer (Orbitrap Elite Hybrid). This platform enabled highly selective mass analysis at a routine mass accuracy of ˜2 ppm. MCPD esters were monitored in ESI positive ion mode (ESI⁺). Under these conditions the observed MCPD ester ions were the [M+NH₄]⁺ and [M+Na]⁺ adducts.

Data Interpretation

The relative quantification of MCPDE was performed by first extracting the ion chromatograms of the [M+NH₄]⁺ and [M+Na]⁺ adducts at their respective m/z value in a 10 ppm mass window and then integrating the resulting peak areas at the corresponding chromatographic retention time.

For every experiment, the peak areas of the PP, PO, 00 MCPD were summed up, and divided by the sum of their respective stable isotope labeled internal standards peak areas. This allowed easy and fast comparison and visualization of the relative MCPDE levels in the investigated samples.

Analysis of Total MCPD by the Official AOCS Method

Where indicated, the samples were sent to the external laboratory SGS (SGS Germany GmbH, Hamburg, Germany) for confirmatory analysis by the Official AOCS Cd 29b-13 method, which is based on gas chromatography-mass spectrometry (GC-MS). This method determines the free 2-, and 3-MCPD and the sum of their respective esterified (bound) forms each.

In-Ampoulle Heat Treatment of the Samples

The heat treatment of crude oil samples was performed in sealed glass ampoules under nitrogen for 2 h at 230° C. in a Thermo Scientific Heraeus oven (serie 6100). The glass ampoules were fabricated from glass Pasteur pipettes using a Bunsen gas burner. These conditions were chosen in order to mimic the thermal conditions used during edible-oil deodorisation.

### Example 1: Benefit of High Temperature Water Washing of Palm Oil

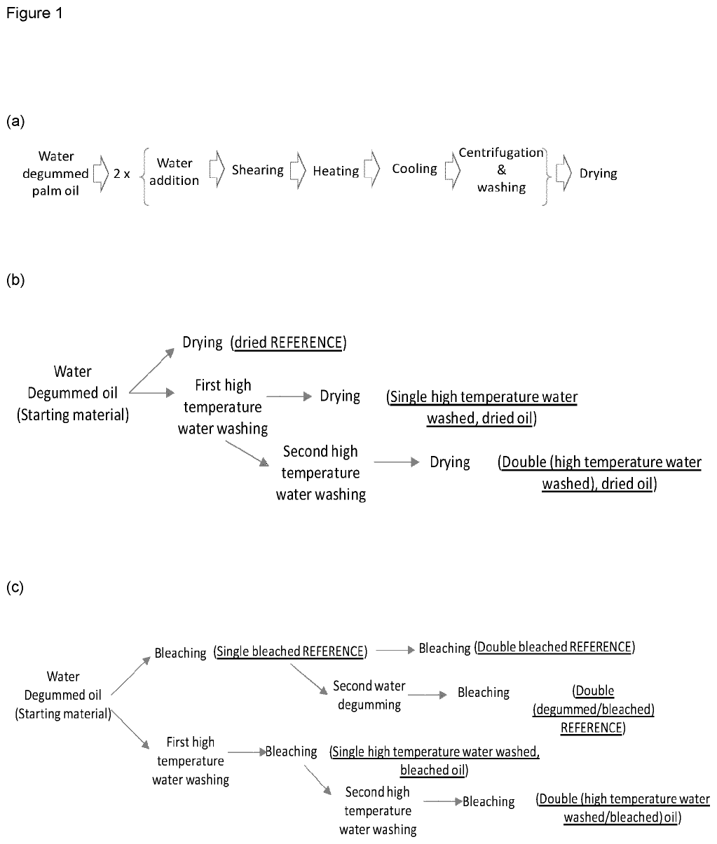

The key steps of this example are summarized in the schematic shown in FIG. 1(a).

Industrially Produced Crude Palm Oil

Industrially produced crude palm oil was purchased from Nutriswiss (Lyss, Switzerland). The oil was subjected to mitigation trials followed by a centrifugation based pre-purification.

6 L of crude palm oil was melted by heating to 80° C. in a water bath. The oil was homogenized by manual shaking. 1 L aliquots were transferred into 1 L polypropylene tubes (Sorvall 1000 mL) and centrifuged at 8000 g for 15 min at 40° C. in a Thermo Scientific Heraeus Cryofuge 8500i centrifuge. The sediment-free upper 90% (v/v) of the oil was used for further trials.

Water Degumming of Palm Oil

The oil was heated to 80° C. and water was added in amount of 2% by volume of the oil. The oil was then sheared (Silverson LM-5A) for 4 min at 1500 rpm at 80° C. Centrifugation followed for 15 min at 15000 g at 40° C. (Centrifuge 5804R, Eppendorf, VWR International GmbH, Switzerland). The upper 90% (v/v) degummed liquid phase was used for further work.

High Temperature Water Washing of Water Degummed Palm Oil (Executed Two Times Consecutively)

4% (v/v) water was added to water degummed palm oil. The mixture was homogenized by shearing in a Silverson LM-5A for 30 min at 5000 rpm at 80° C. and then heating at 165° C. for 1 h in a Thermo Scientific Heraeus oven (serie 6100). Note that this heat treatment does not yet induce formation of MCPD detectable by the herein used LC-MS method.

Following this heat treatment, the samples were cooled at room temperature for 30 min and then put in a 40° C. water bath for 10 min and then subjected to centrifugation for 15 min at 15000 g at 40° C. (Centrifuge 5804R, Eppendorf, VWR International GmbH, Switzerland). The upper 90% (v/v) liquid phase (auxiliary degummed palm oil) was taken off for further work.

The mixture was heated to 80° C. and addition of water (2% by the volume of the mixture) followed and the mixture was sheared (Silverson LM-5A) for 2 min at 5000 rpm keeping the temperature at 80° C. Centrifugation followed for 15 min at 15000 g at 40° C. (Centrifuge 5804R, Eppendorf, VWR International GmbH, Switzerland). The upper 90% (v/v) was taken off for further work and this washing process was repeated two more times.

Drying of Oils

The oil was transferred into a round 0.5 L or 200 mL rotary evaporator flask heated at 85° C. in a water bath. The flask was rotated at 240 rpm and temperature was increased and kept at 95° C. while vacuum was applied at 50 mbar for 20 min.

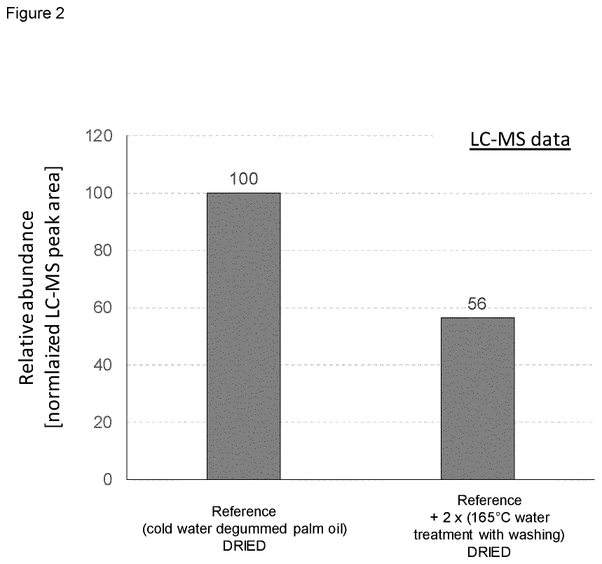

The resulting oil samples were subjected to heat treatment in ampoules as described above in order to simulate the formation of MCPDEs and were analysed by LC-MS for their MCPDE content accordingly. Results are shown in FIG. 2.

A benefit of more than 40% less MCPDE is shown in FIG. 2, depicting the MCPDE levels detected in the reference oil as 100%, and the MCPDE levels in the oil that was purified by the high temperature water washing process.

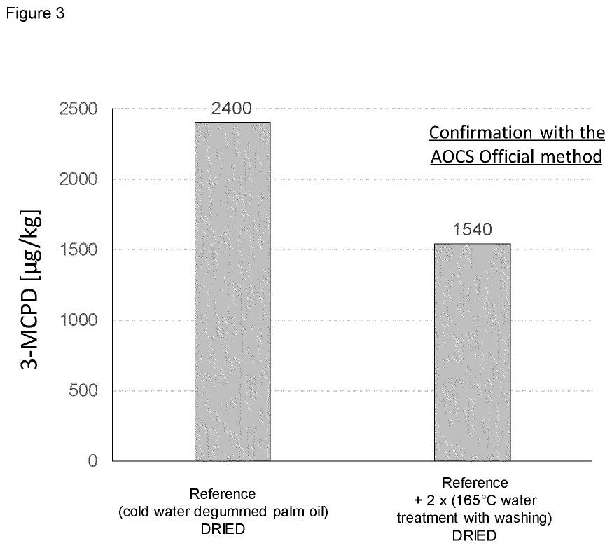

The absolute 3-MCPD levels were determined by GC-MS using the Official AOCS Cd 29b-13 method at SGS laboratory. The results shown in FIG. 3 confirm that the application of high temperature water washing treatment results in 40% reduction in 3-MCPD corresponding in this case to about 0.7 ppm mitigation.

### Example 2—Benefit of High Temperature Water Washing when Applied to Already Bleached Oil (Synergistic Effect Between the Consecutive Bleaching and the High Temperature Waster Washing)

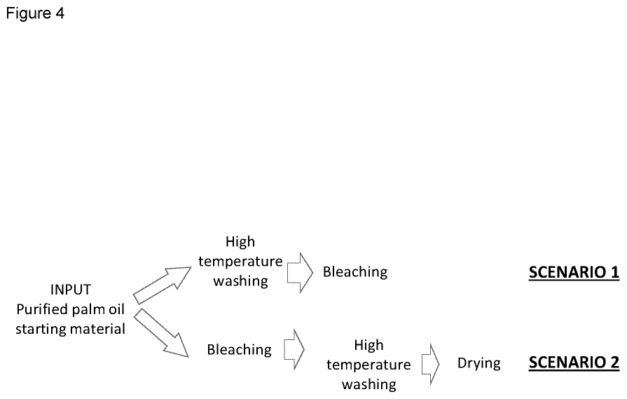

The key steps of this example are summarized in the schematics of FIG. 4.

Both Scenario 1 and 2 includes a high temperature water washing and a bleaching step, but in reversed order. Further, Scenario 2 incudes a final drying step to remove the residual water from the oil and thus enable appropriate comparison.

Preparation of the Pre-Purified Input Oil

Industrially produced crude palm oil was purchased from Nutriswiss (Lyss, Switzerland).

6 L of crude palm oil was melted by heating to 80° C. in a water bath. The oil was homogenized by manual shaking. 1 L aliquots were transferred into 1 L polypropylene tubes (Sorvall 1000 mL) and centrifuged at 8000 g for 15 min at 40° C. in a Thermo Scientific Heraeus Cryofuge 8500i centrifuge. The sediment-free upper 90% (v/v) of the oil was used for further trials.

Water Degumming of Palm Oil

The oil was heated to 80° C. and water was added in amount of 2% by volume of the oil. The oil was then sheared (Silverson LM-5A) for 4 min at 1500 rpm at 80° C. Centrifugation followed for 15 min at 15000 g at 40° C. (Centrifuge 5804R, Eppendorf, VWR International GmbH, Switzerland). The upper 90% (v/v) degummed liquid phase was used for further work.

High Temperature Washing of Water Degummed Palm Oil

4% (v/v) water was added to water degummed palm oil. The mixture was homogenized by shearing in a Silverson LM-5A for 30 min at 5000 rpm at 80° C. and then heating at 165° C. for 1 h in a Thermo Scientific Heraeus oven (serie 6100). Note that this heat treatment does not yet induce formation of MCPD.

Following this heat treatment, the samples were cooled at room temperature for 30 min and then put in a 40° C. water bath for 10 min and then subjected to centrifugation for 15 min at 15000 g at 40° C. (Centrifuge 5804R, Eppendorf, VWR International GmbH, Switzerland). The upper 90% (v/v) liquid phase (auxiliary degummed palm oil) was taken off for further work.

The mixture was heated to 80° C. and addition of water (2% by the volume of the mixture) followed and the mixture was sheared (Silverson LM-5A) for 2 min at 5000 rpm keeping the temperature at 80° C. Centrifugation followed for 15 min at 15000 g at 40° C. (Centrifuge 5804R, Eppendorf, VWR International GmbH, Switzerland). The upper 90% (v/v) was taken off for further work and this washing process was repeated two more times.

This pre-purified palm oil was split into two aliquots which were used as input oil for the mitigation Scenarios 1 and 2 respectively, as shown in FIG. 4 and further described below.

Experimental Details of Mitigation Scenario 1 from FIG. 4

High Temperature Water Washing

4% (v/v) water was added to water degummed, bleached palm oil. The mixture was homogenized by shearing in a Silverson LM-5A for 30 min at 5000 rpm at 80° C. and then heating at 165° C. for 1 h in a Thermo Scientific Heraeus oven (serie 6100). Note that this heat treatment does not yet induce formation of MCPD.

Following this heat treatment, the samples were cooled at room temperature for 30 min and then put in a 40° C. water bath for 10 min and then subjected to centrifugation for 15 min at 15000 g at 40° C. (Centrifuge 5804R, Eppendorf, VWR International GmbH, Switzerland). The upper 90% (v/v) liquid phase was taken off for further work.

The mixture was heated to 80° C. and addition of water (2% by the volume of the mixture) followed and the mixture was sheared (Silverson LM-5A) for 2 min at 5000 rpm keeping the temperature at 80° C. Centrifugation followed for 15 min at 15000 g at 40° C. (Centrifuge 5804R, Eppendorf, VWR International GmbH, Switzerland). The upper 90% (v/v) was taken off for further work and this washing process was repeated two more times.

Washing of Bleaching Clay

3 g clay (w/w) was mixed with 97 g Milli-Q water, manually shaken, then centrifuged at 4500 g for 10 min and water removed, 3 times consecutively. The wet clay was then dried in an oven at 50° C. overnight.

Bleaching

The above high-temperature-water-washed palm oil was transferred into a round 0.25 L rotary evaporator flask heated at 85° C. in a water bath and 2% of previously washed and dried bleaching earth (Tonsil 112FF) was added. The flask was rotated at 240 rpm and temperature was increased and kept at 95° C. while vacuum was applied at 50 mbar for 20 min. Finally, the oil was filtered via a vacuum Millipore filtration apparatus using a Whatman filter 8 um.

Experimental Details of Mitigation Scenario 2 from FIG. 4

The pre-purified Input oil was transferred into a round 0.25 L rotary evaporator flask heated at 85° C. in a water bath and 2% of previously washed and dried bleaching earth (Tonsil 112FF) was added. The flask was rotated at 240 rpm and temperature was increased and kept at 95° C. while vacuum was applied at 50 mbar for 20 min. Finally, the oil was filtered via a vacuum Millipore filtration apparatus using a Whatman filter 8 um.

High temperature water washing of the bleached oil 4% (v/v) water was added to the above described bleached palm oil. The mixture was homogenized by shearing in a Silverson LM-5A for 30 min at 5000 rpm at 80° C. and then heating at 165° C. for 1 h in a Thermo Scientific Heraeus oven (serie 6100). Note that this heat treatment does not yet induce formation of MCPD.

Following this heat treatment, the samples were cooled at room temperature for 30 min and then put in a 40° C. water bath for 10 min and then subjected to centrifugation for 15 min at 15000 g at 40° C. (Centrifuge 5804R, Eppendorf, VWR International GmbH, Switzerland). The upper 90% (v/v) liquid phase was taken off for further work.

The mixture was heated to 80° C. and addition of water (2% by the volume of the mixture) followed and the mixture was sheared (Silverson LM-5A) for 2 min at 5000 rpm keeping the temperature at 80° C. Centrifugation followed for 15 min at 15000 g at 40° C. (Centrifuge 5804R, Eppendorf, VWR International GmbH, Switzerland). The upper 90% (v/v) was taken off for further work and this washing process was repeated two more times.

Drying of Oil

The oil was transferred into a round 0.5 L or 200 mL rotary evaporator flask heated at 85° C. in a water bath. The flask was rotated at 240 rpm and temperature was increased and kept at 95° C. while vacuum was applied at 50 mbar for 20 min.

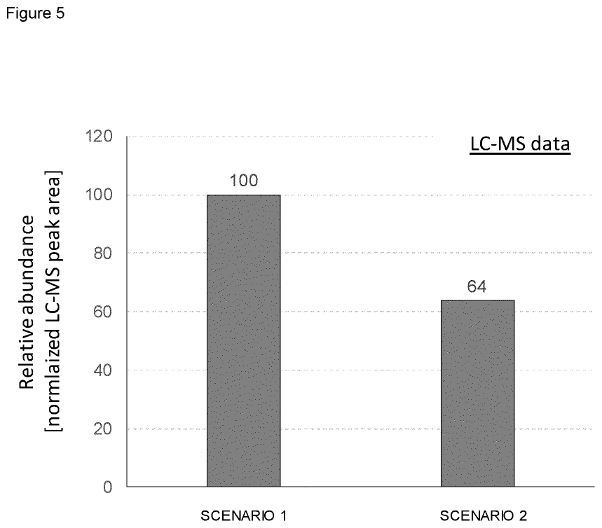

The resulting samples were subjected to heat treatment in ampoules as described above in order to simulate the formation of MCPDEs and were analysed by LC-MS for their MCPDE content accordingly. Results are shown in FIG. 5.

Scenario 2 resulted in about 36% less MCPDE in comparison to Scenario 1 showing the benefit of performing the high temperature water washing after the bleaching process. This benefit has been confirmed also by GC-MS approach using the Official AOCS Cd 29b-13 method at SGS laboratory.

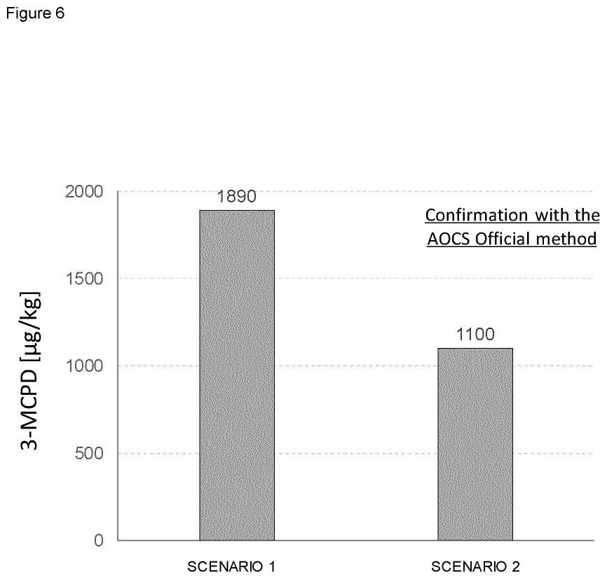

This latter is depicted in FIG. 6, showing that the absolute 3-MCPD levels measured in Scenario 2 were 40% lower in comparison to Scenario 1, corresponding to more than 0.7 ppm mitigation benefit when the high temperature water washing was performed after the bleaching process.

Description of ampoule heating and analytical procedures can be found as previously described above.

### Example 3

Benefit of Two-Steps High Temperature Water Washing on Dried Oils

The key steps of this example are summarized in the schematic in FIG. 1(b).

Industrially produced crude palm oil

Industrially produced crude palm oil was purchased from Nutriswiss (Lyss, Switzerland). The oil was subjected to centrifugation based pre-purification. 5 L of the industrial crude palm oil was equilibrated at 60° C. for 30 min in a water bath and then homogenized vigorously by manual shaking. 40 mL aliquots were transferred into 50 mL Falcon® tubes and were centrifuged at 15000 g for 15 min at 40° C. (Centrifuge 5804R, Eppendorf, VWR International GmbH, Switzerland). The sediment-free upper 90% v/v corresponding to 36 mL aliquots were taken from each Falcon® tube, were combined and used for further work.

Water Degumming of Palm Oil

The oil was heated to 80° C. and 2% v/v of water heated to 80° C. was then added. The oil was then sheared (Silverson LM-5A) for 4 min at 1500 rpm at 80° C. Centrifugation followed for 15 min at 15000 g at 40° C. (Centrifuge 5804R, Eppendorf, VWR International GmbH, Switzerland). The upper 90% (v/v) degummed liquid phase was used for further work.

High Temperature Water Washing

18% v/v water was added to water degummed palm oil. The mixture was homogenized by shearing in a Silverson LM-5A for 30 min at 5000 rpm at 80° C. and then heated in closed glass vessel at 165° C. for 1 h in a Thermo Scientific Heraeus oven (serie 6100) with 10 sec manual shaking at every 10 min internals. Note that this heat treatment does not yet induce formation of MCPD.

Following heating, the mixture was cooled down by keeping it at room temperature for 5 min, then putting it into a room temperature water bath for 10 min. Then the mixture was equilibrated at 40° C. for 10 min and centrifuged for 15 min at 15000 g at 40° C. (Centrifuge 5804R, Eppendorf, VWR International GmbH, Switzerland). The upper 90% (v/v) degummed liquid phase was taken off and used for further work.

In the next step 2% v/v of water was added to the above upper 90% of degummed liquid phase. The mixture was then sheared (Silverson LM-5A) for 4 min at 5000 rpm at 80° C. and equilibrated at 40° C. for 10 min. Centrifugation followed for 15 min at 15000 g at 40° C. (Centrifuge 5804R, Eppendorf, VWR International GmbH, Switzerland). The upper 90% (v/v) was taken off for further work.

Drying of Oils

The oil was transferred into a round 0.2 L rotary evaporator flask heated at 95° C. in a water bath. The flask was rotated at 240 rpm and vacuum was applied at 20 mbar for 20 min.

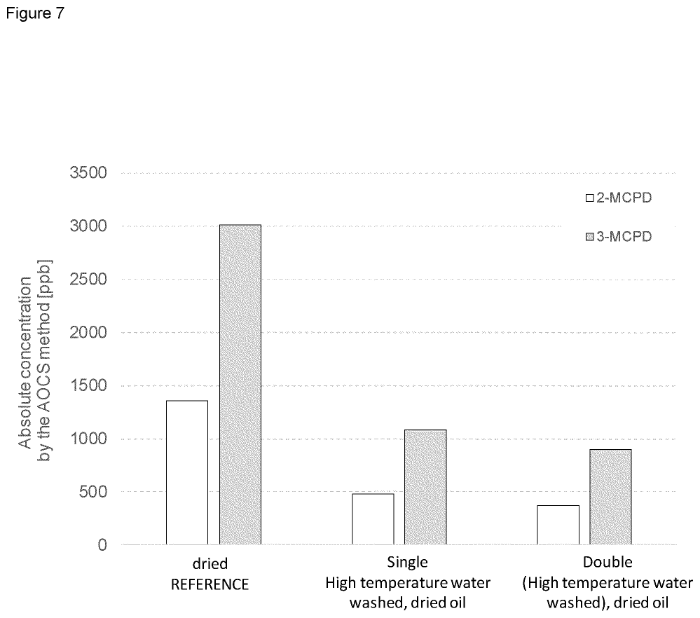

The resulting samples according to the schematic above were subjected to analysis by the Official AOCS Cd 29b-13 method at SGS laboratory. The results shown in FIG. 7 confirm that the application of high temperature water washing without any bleaching process results in about 60% reduction in 3-MCPD in dried oils corresponding in this case to about 1.9 ppm mitigation. Even bigger benefit is observed when high temperature water washing is repeated leading to 0.89 ppm final concentration of 3-MCPD— see the “Double (high temperature water washed) dried oil” column in FIG. 7.

### Example 4

Benefit of Single and Double High Temperature Water Washing in Combination with Bleaching

The key steps of this example are summarized in the schematic in FIG. 1(c).

Industrially Produced Crude Palm Oil

Industrially produced crude palm oil was purchased from Nutriswiss (Lyss, Switzerland). The oil was subjected to centrifugation based pre-purification. 5 L of the industrial crude palm oil was equilibrated at 60° C. for 30 min in a water bath and then homogenized vigorously by manual shaking. 40 mL aliquots were transferred into 50 mL Falcon® tubes and were centrifuged at 15000 g for 15 min at 40° C. (Centrifuge 5804R, Eppendorf, VWR International GmbH, Switzerland). The sediment-free upper 90% v/v corresponding to 36 mL aliquots were taken from each Falcon® tube, were combined and used for further work.

Water Degumming of Palm Oil

The oil was heated to 80° C. and 2% v/v of water heated to 80° C. was then added. The oil was then sheared (Silverson LM-5A) for 4 min at 1500 rpm at 80° C. Centrifugation followed for 15 min at 15000 g at 40° C. (Centrifuge 5804R, Eppendorf, VWR International GmbH, Switzerland). The upper 90% (v/v) degummed liquid phase was used for further work.

High Temperature Water Washing

18% v/v water was added to water degummed palm oil. The mixture was homogenized by shearing in a Silverson LM-5A for 30 min at 5000 rpm at 80° C. and then heated in closed glass vessel at 165° C. for 1 h in a Thermo Scientific Heraeus oven (serie 6100) with 10 sec manual shaking at every 10 min internals. Note that this heat treatment does not yet induce formation of MCPD.

Following heating, the mixture was cooled down by keeping it at room temperature for 5 min, then putting it into a room temperature water bath for 10 min. Then the mixture was equilibrated at 40° C. for 10 min and centrifuged for 15 min at 15000 g at 40° C. (Centrifuge 5804R, Eppendorf, VWR International GmbH, Switzerland). The upper 90% (v/v) degummed liquid phase was taken off and used for further work.

In the next step 2% v/v of water was added to the above upper 90% of degummed liquid phase. The mixture was then sheared (Silverson LM-5A) for 4 min at 5000 rpm at 80° C. and equilibrated at 40° C. for 10 min. Centrifugation followed for 15 min at 15000 g at 40° C. (Centrifuge 5804R, Eppendorf, VWR International GmbH, Switzerland). The upper 90% (v/v) degummed/washed liquid phase (auxiliary degummed palm oil) was taken off for further work.

Drying of Oils

The oil was transferred into a round 0.2 L rotary evaporator flask heated at 95° C. in a water bath. The flask was rotated at 240 rpm and vacuum was applied at 20 mbar for 20 min.

Washing of Bleaching Clay 3 g clay (w/w) was mixed with 97 g Milli-Q water, manually shaken, then centrifuged at 4500 g for 10 min and water removed by pipetting, 3 times consecutively. The wet clay was then dried in an oven at 50° C. for 24 h.

Bleaching of “High Temperature Water Washed” Palm Oil

The “high temperature water washed” palm oil was transferred into a round 0.2 L rotary evaporator flask heated at 90° C. in a water bath and 2% w/w of previously washed and dried bleaching earth (Tonsil 112FF) was added. The flask was rotated at 240 rpm and vacuum was applied at 50 mbar for 20 min. Finally, the oil was filtered via a vacuum Millipore filtration apparatus using a Whatman filter 8 um.

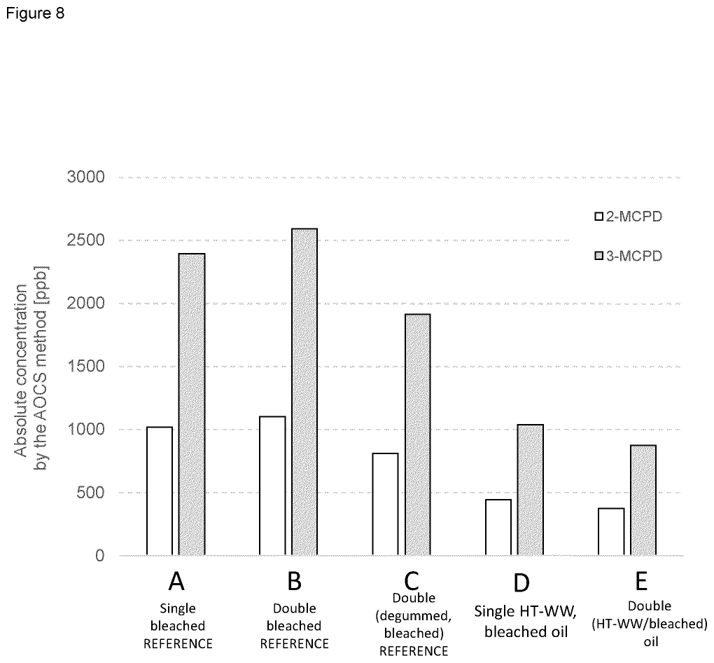

The resulting samples according to the schematic above were subjected to analysis by the Official AOCS Cd 29b-13 method at SGS laboratory. The results shown in FIG. 8 confirm that the application of high temperature water washing in combination with bleaching process results in about 55% reduction in 3-MCPD corresponding in this case to about 1.3 ppm mitigation, see column A versus column D. The biggest benefit is observed when high temperature water washing and bleaching are repeated consecutively leading to 0.88 ppm final concentration of 3-MCPD— see the “Double (High temperature water washed/bleached) oil” column E in FIG. 8. This latter corresponds to about 63% mitigation, see column A versus E.

All publications mentioned in the above specification are herein incorporated by reference. Various modifications and variations of the disclosed methods, uses and products of the invention will be apparent to the skilled person without departing from the scope and spirit of the invention. Although the invention has been disclosed in connection with specific preferred embodiments, it should be understood that the invention as claimed should not be unduly limited to such specific embodiments. Indeed, various modifications of the disclosed modes for carrying out the invention, which are obvious to the skilled person are intended to be within the scope of the following claims.

1. A method for preventing or reducing the formation of monochloropropanediols (MCPDs) or monochloropropanediol esters (MCPDEs) in triacylglyceride oil, comprising the steps:
admixing a starting triacylglyceride oil with a liquid to form an admixture, wherein said liquid is selected from one or more of water, acid solution, base solution, phospholipid solution, and surfactant solution;
homogenizing the admixture;
performing one or more of the following steps
1. heating the admixture while homogenizing; and
2. heating the admixture;
cooling the admixture to under 100° C.;
separating aqueous insoluble phase and crystallized components from the admixture and/or applying one or more processes to the admixture selected from the group consisting of degumming, physical refining, chemical refining, neutralization, interesterification, bleaching, dewaxing and fractionation; and
applying heat treatment to the admixture.

2. The method of claim 1, wherein the liquid is water.

3. The method of claim 1, wherein the triacylglyceride oil is selected from the group consisting of a plant oil, animal oil, fish oil, yeast oil, fungi and algal oil.

4. The method of claim 1, wherein the triacylglyceride oil is palm oil or fractions obtained from palm oil.

5. The method of claim 1, wherein the starting triacylglyceride oil is fish oil or fractions obtained from fish oil.

6. The method of claim 1, wherein the starting triacylglyceride oil is a crude oil.

7. The method of claim 1, wherein the insoluble and crystallized components are separated from the triacylglyceride oil admixture by one or more of filtration, decantation, centrifugation, pumping, and draining.

8. The method of claim 1, wherein the starting triacylglyceride oil is an oil that has been bleached.

9. The method of claim 1, wherein the starting triacylglyceride oil has been degummed and/or neutralized and/or bleached before the admixing step.

10. The method of claim 1, including heating to a temperature above 100° C.

11. The method of claim 1, including heating in a closed vessel under a pressure higher than 1 bar.

12. A purified triacylglyceride oil obtainable by the method of claim 1.
